(19) United States
(12) Patent Application Publication
(10) Pub. No.: US 2013/0152544 A1
(43) Pub. Date: Jun. 20, 2013

(54) JET ENGINE

(71) Applicant: José Ramón MARTÍNEZ CASAÑ, Valencia (ES)

(72) Inventor: José Ramón MARTÍNEZ CASAÑ, Valencia (ES)

(21) Appl. No.: 13/714,133

(22) Filed: Dec. 13, 2012

(30) Foreign Application Priority Data
Dec. 16, 2011 (EP) 11382384.3

(51) Int. Cl. F02K 3/06

(52) U.S. Cl. CPC F02K 3/06
USPC 60/226.1; 60/269

(57) ABSTRACT

A reaction engine is disclosed mainly intended for aviation, but which as described herein can be adapted for an industrial engine, which makes use of spherical chambers and a pressure system in the blades of the rotor-stator unit which permits a perfect adjustment between said blades and the inner face of the stator, preventing pressure losses. While edges likewise articulated in the same way as the blades, execute a labyrinth seal.

### OBJECT OF THE INVENTION

The present invention pertains to the field of reaction engines.

The object of the invention consists of an improved reaction engine which, thanks to its special characteristics, allows for better performance.

### BACKGROUND OF THE INVENTION

A turbojet engine is a type of internal combustion engine frequently used to propel an aircraft. The air is dragged to a rotary compressor through the air intake and is compressed, during several successive stages, at high pressure before entering the combustion chamber. The fuel is mixed with the compressed air and ignited. This combustion process considerably increases the temperature of the gas. The result of the combustion leaves to expand through the turbine, where the energy is extracted to move the compressor. Although this expansion process reduces both the temperature and the gas pressure, they are both generally kept higher than the averages thereof. The flue gas leaving the turbine expands to the atmospheric pressure through a propulsion nozzle, producing a high speed stream. If the speed of this stream of gasses exceeds the speed of the airplane, then there is a net thrust forward.

Under normal conditions, the action of the compressor pump ensures against any backward movement of the flow, thus achieving a continuous process in the engine. In fact, the complete process is similar to the four stroke cycle, but where the admission, compression, ignition, expansion and outlet are carried out simultaneously, but in different sections of the engine. The efficiency of a reaction engine strongly depends on the pressure ratios and the turbine temperature.

Comparing the turbojet with the conventional propeller engine, the former takes a relatively small amount of air mass and accelerates it considerably, while a propeller uses a large air mass and only accelerates it a bit. The exit of gases from a turbojet engine at high speeds makes it effective at high speeds, especially for supersonic jets, and at high altitudes. In slower airplanes and those that only make short flights, a gas turbine driven by a propeller, known as a turboprop, is more common and efficient.

The simplest turbojet has a single turbine, wherein a single shaft connects the turbine to the compressor. Designs with higher pressure ratios tend to have two concentric shafts, improving the stability of the compressor. The high pressure shaft connects the compressor and high pressure turbine. This external high-pressure coil, with the combustion chamber, forms the core or engine generator. The internal shaft connects the low-pressure compressor with the los-pressure turbine. Both coils can operate freely in order to achieve optimal velocities, like in supersonic airplanes such as the Concord. The main components of a reaction engine are similar in different types of engines, although not all kinds have all of the components. The main parts include:
Inlet or air intake: for subsonic airplanes, the air intake towards the reaction engine does not present special difficulties, and essentially consists of an opening which is designed to reduce resistance like any other airplane element. Nevertheless, the air which reaches the compressor of a normal reactor must travel at a speed below the speed of sound, including in supersonic airplanes, to maintain fluid mechanics in the compressor and the turbine blades. At supersonic speeds, the shock waves which form at the air inlet reduce the pressure in the compressor. Some supersonic air inlets use systems, such as a cone or ramp, to increase the pressure and make it more efficient against shock waves.
Compressor or fan: the compressor is made up of several stages. Each stage consists of blades which rotate and stators which remain stationary. Air passes through the compressor, increasing its pressure and temperature. The energy is derived from the turbine which passes through the rotor.
Shaft, which is responsible for transporting energy from the turbine to the compressor and operates along the engine. There can be up to three concentric rotors, rotating at independent speeds, operating in both the groups of turbines and compressors.
Combustion chamber, where the fuel is continuously burned in the compressed air.
Turbine, acting as a wind mill, extracting energy from the hot gases produced in the combustion chamber. This energy is used to move the compressor through the rotor, bypass fan, propellers or even to convert the energy to use it in another place through an accessory box with different outlets. Relatively cold air can be used to cool the combustion chamber and the turbine blades and prevent them from melting.
Post combustor: mainly used in military airplanes, it produces an additional thrust, burning fuel in the nozzle area, generally inefficiently, to increase the inlet temperature of the nozzle.
Nozzle or outlet: hot gases leave the engine towards the atmosphere through a nozzle, whose goal is to produce an increase in the speed of these gases. In most cases, the nozzle is convergent or of fixed flow area. Supersonic nozzle: if the pressure ratio of the nozzle (the division between entrance pressure of the nozzle and the atmospheric pressure) is very high, in order to maximize the thrust it can be efficient, in spite of the increase in weight, use a convergent-divergent nozzle or a Laval nozzle. This type of nozzle is initially convergent, but beyond the throat (the narrowest area), it begins to increase its area in the divergent part.

The optimization of an engine depends on many factors, including the design of the air intake, the total size, the number of compressor stages, the type of fuel, the number of outlet stages, the component materials, the amount of air derived in the cases when air diversion is used, etc.

Likewise in precooled turbojet engines, engines that need to operate at low hypersonic speeds can theoretically have a higher performance if the heat exchanger is used to cool the entering air. The low temperature permits the use of lighter materials and the injection of more fuel. This idea was converted into designs such as SABRE, which would allow orbital flight in one stage, and ATREX, which can use engines as boosters for spatial vehicles. This occurs similarly in a rocket at the moment of take off. A 10g force increases and the thrust is linearly accelerated.

Scramjets or supersonic combustion ramjets are the evolution of the ramjet which permits operation at greater speeds. They share a similar structure to the ramjet, being basically a tube which compresses air with mobile parts. Nevertheless, in scramjets the airflow is supersonic through the entire engine, without needing to use the diffusers of the ramjets to maintain the subsonic air speed. Scramjets begin to operate at Mach 4 speeds and have a maximum theoretical speed of Mach 17. The main drawbacks of scramjets are those related to cooling due to heating at high speeds.

### DESCRIPTION OF THE INVENTION

The object of the invention is a high performance, energetically efficient engine, which features a compressor block defined by a high speed, eccentric rotor turbo compressor with a rotor that, in a preferred embodiment of the object of invention, comprises four self-adjusting, cross-sectioned blades—self-adjusting, since they are equipped with adjusting mechanisms defined by springs inserted in the interior thereof—on the stator with automatic recovery. This system facilitates closure in the radial direction while closure in the axial direction is carried out by two retainer rings situated on the two inner faces of the stator.

The aforementioned stator has an air inlet channel situated in the cool part of the stator and is responsible for supplying the turbo compressor. This duct connects to an inlet channel situated in the rotor chamber and is offset 45° with respect to the air exhaust channel, already compressed. The shutoff between the two channels is ensured by means of three cross-sectioned blades with an edge that features an essentially serrated shape or a key shape (preferably double wedge), which make a labyrinth seal and self-adjust with respect to the peripheral face of the rotor. In its hot area, the stator has channels—preferably three, but this number can vary according to the embodiment—where the electronic distribution rods are situated. These piston rods control the shock absorbers of the expulsion valves and the possible imbalances that may arise between the pressures of the inlet valve and the distribution rod.

Also located in the aforementioned hot part of the stator is the annular pressure and regulation chamber which directly connects to the distribution rods, while a non-return valve is preferably used for connecting to the compressor, together with an electronically actuated relief valve of the compressor and a pressure balanced two-way valve which directly actuates either only on the boiler or on the boiler and the pressure and regulator chamber.

Another important part of the object of invention is made up of the main combustion block, formed by a specific number of spherical, air-cooled chambers, preferably six, where in each one of said chambers an air inlet channel, an exhaust channel and housings for the fuel injector and at least one spark plug are respectively found. The inlet guide valves, which are compact groups which regulate the entrance of air, are placed in the aforementioned inlet channels, while the expulsion guide valves, which are cooled compact groups preferably lubricated by three pressure oil circuits, are placed in the exhaust channels.

The engine torque transmission systems of the engine described herein can be made of one, two or three coaxial shafts (a main or primary shaft, a second shaft and a third shaft) responsible for distributing the driving force to all parts of the transmission system of the object of invention. The first shaft connects the two high-pressure turbines, which is where the operating pressure is generated, with the reduction system gear box and auxiliary services (pressure and lubricating pumps, recovery pump, current generator and start-up motor) while the second shaft transmits power from the reduction system gear box to the compressor rotor shaft; likewise, the third shaft connects the three low-pressure turbines from the hot part with the planetary part and this, in turn, transmits the torque to the frontal low-pressure turbines and to the fan.

One of the differentiating characteristics of the object of invention comes from the lubricating system thereof, given that this is an engine with a specific configuration, and in turn a specific lubrication is required. The lubricating system of the engine disclosed herein used pressure generated by pressure pumps, channelling and recoveries arranged along them, or at specific points of the lubricating circuit; thus achieving the lubrication of the turbine bearings, the inlet and recovery valves, the reduction and planetary gear boxes.

The compressor block of the engine disclosed herein comprises a high speed, eccentric rotor turbo compressor with a rotor which features four cross-sectioned, self-adjusting blades on the stator with automatic recovery; this characteristic is achieved by inserting one or more springs inside each blade—more specifically they are arranged orthogonally to one of the shorter sides of the blade—so that they exert a force that ensure the perfect adjustment between the other end—the other shorter side—on the inner walls of the stator. This system facilitates closure in the radial direction while closure in the axial direction is performed by two retainer seals situated on the two lower faces of the stator.

The aforementioned stator features an air inlet channel situated in the cold part of the stator and is responsible for supplying the turbo compressor. This duct connects to an inlet channel situated in the rotor chamber and is offset 45° with respect to the air exhaust channel, already compressed. The shutoff between the two channels is ensured by means of three cross-sectioned blades, which execute a labyrinth seal and self-adjust with respect to the peripheral face of the rotor. In the hot area of the stator there are four housings where the electronic distribution rods are situated. These piston rods control the shock absorbers of the expulsion valves and the imbalance between the pressures of the inlet valve and the distribution rod. Also located in this part of the stator is the annular pressure and regulation chamber. This chamber directly connects to the distribution rods, while a non-return valve is used for connecting to the compressor. An electronically actuated relief valve of the compressor and a pressure balanced two-way valve which directly actuates either only on the boiler or on the boiler and the pressure and regulator chamber are also found in this area. The stator is closed with a lid which ensures that no pressure is lost in the turbo compressor supply and also wraps the entire reduction system. This lid channels the low pressure air, coming from the low pressure compressor, towards the stator inlet chamber.

The aforementioned chamber block features a main combustion block and is formed by four spherical chambers. In each one of said chambers is an air inlet channel—wherein the inlet guide valves, which are compact groups which regulate the entrance of air, is placed—, one or more exhaust channels—wherein the exhaust guide valves, which are compact groups cooled and lubricated by pressure oil circuits, are placed—and the housings for the fuel injector and spark plug.

The engine torque transmission is carried out by a system made up of two shafts, which are responsible for distributing the drive force to all parts of the system. The first shaft connects the four high-pressure turbines, which is where the operating pressure is generated, to the reduction system gear box.

The second shaft transmits power from the reduction system gear box to the shaft of the two low pressure turbines and to the lower shaft where the fan, the current generator and the cooling and lubricating pumps are found.

The engine has a pressure lubricating system via pressure and recovery pumps. This system achieves the lubrication of the turbine bearings, the inlet and recovery valves, the reduction gear box and the planetary gear box.

Finally, it should be highlighted that the engine object of the invention can have one or more turbines, whether they are high pressure or low pressure, and they can be solidly joined to each other.

### DESCRIPTION OF THE DRAWINGS

To complete the description that is being made and with the object of assisting in a better understanding of the characteristics of the invention, in accordance with a preferred example of practical embodiment thereof, accompanying said description as an integral part thereof, is a set of drawings wherein, by way of illustration and not restrictively, the following has been represented:

FIG. 1.—Shows an exploded view of the engine object of the invention.

FIG. 2.—Shows a cross-sectional view of the engine object of the engine, once assembled.

FIG. 3.—Shows a perspective view of the rotor-stator unit as well as the self-adjustable blades.

FIG. 4.—Shows a perspective view of the rotor-stator unit.

FIG. 5.—Shows a perspective, cutaway view of the rotor-stator unit.

FIG. 6.—Show a cross-sectional view of the rotor-stator unit.

FIG. 7.—Shows perspective views of the rotor-stator unit with the blades assembled.

FIG. 8.—Shows a cross-sectional view of a transmission element.

FIG. 9.—Shows a perspective view of the distribution rod.

FIG. 10.—Shows a plan view of the distribution rod.

FIG. 11.—Shows a cross-sectional view of the distribution rod.

FIG. 12.—Shows a plan view of the distribution rod wherein the distribution of inlets and outlets are observed.

FIG. 13.—Shows a cross-sectional view of the rotor-stator unit wherein the blades of the labyrinth seal are observed.

### PREFERRED EMBODIMENT OF THE INVENTION

In view of the figures, a preferred embodiment of the engine (1) object of this invention is described below.

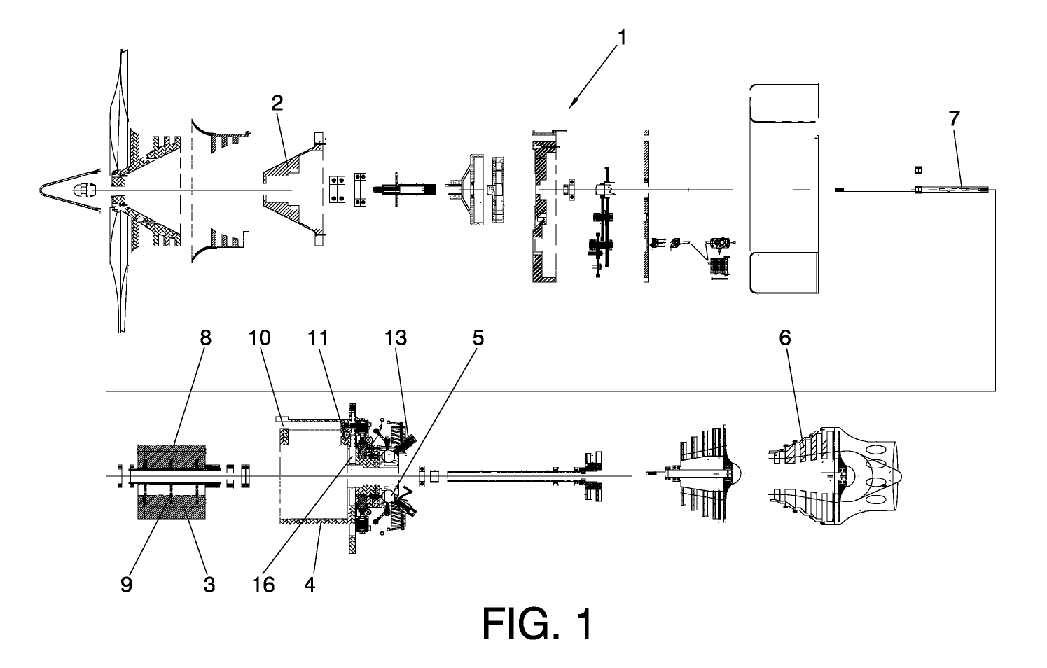

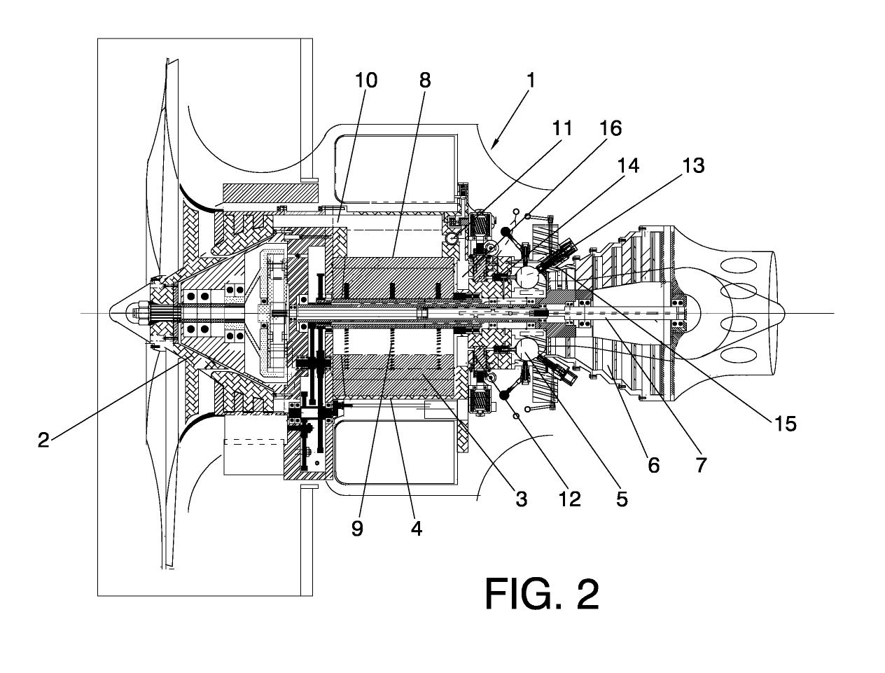

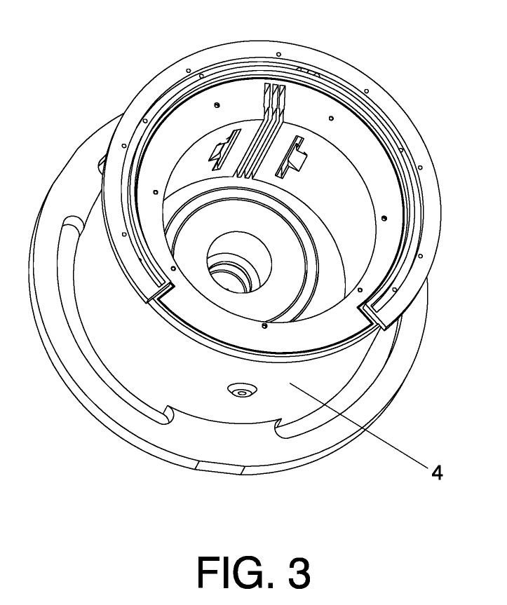

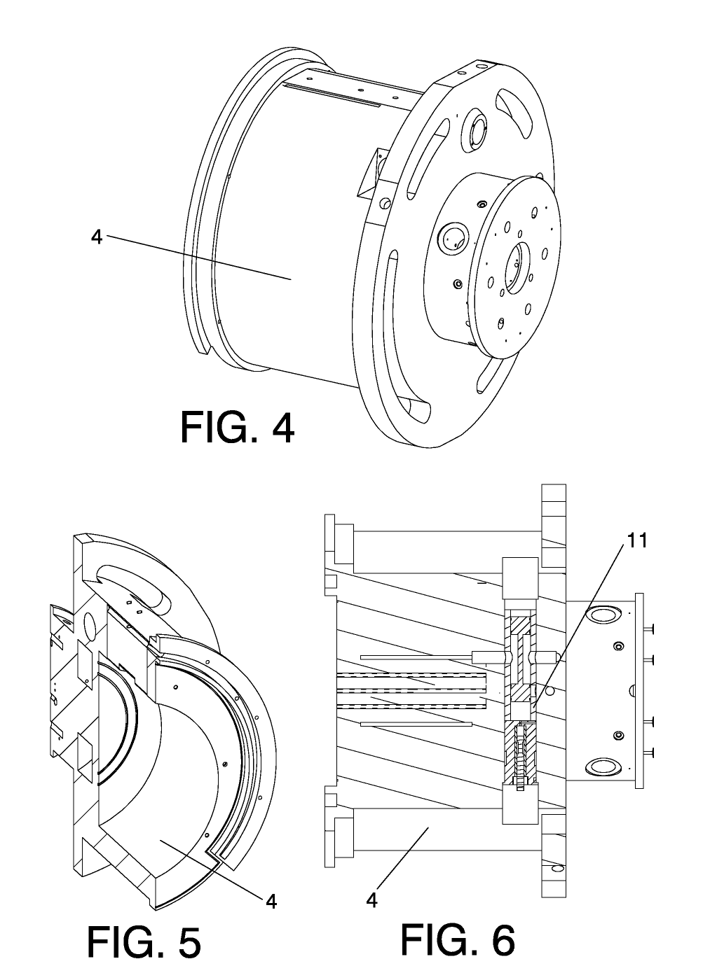

The reaction engine (1) featured in FIG. 2 disclosed herein and whose arrangement and configuration are observed in FIG. 1 bases its operation on an air inlet and a combustion just like all conventional reaction engines, only that the engine (1) disclosed herein makes use of a compressor block (2) equipped with at least a compressor intended to carry out a compression of air that enters the engine (1), which in turn comprises a rotor (3) and a stator (4), a combustion block (5) where at least one combustion chamber (5) is found, where ignition of a fuel is produced together with high pressured air coming from the compressor block (2). The exhaust gases produced in the combustion chamber (5) arrive at least at a turbine (6) which is actuated by said gases, which comprises a torque transmission system with at least one first shaft (7′) which is connected to the compressor (2), thus carrying out the aforementioned air compression. The stator (4) of the compressor (2) of the engine (1) object of the invention is eccentric with respect to the rotor (3), which permits the alternate radial displacement of an array of radial blades (8) disposed on the rotor (3) to carry out the closure in the radial direction of the array formed by the rotor (3) and the stator (4).

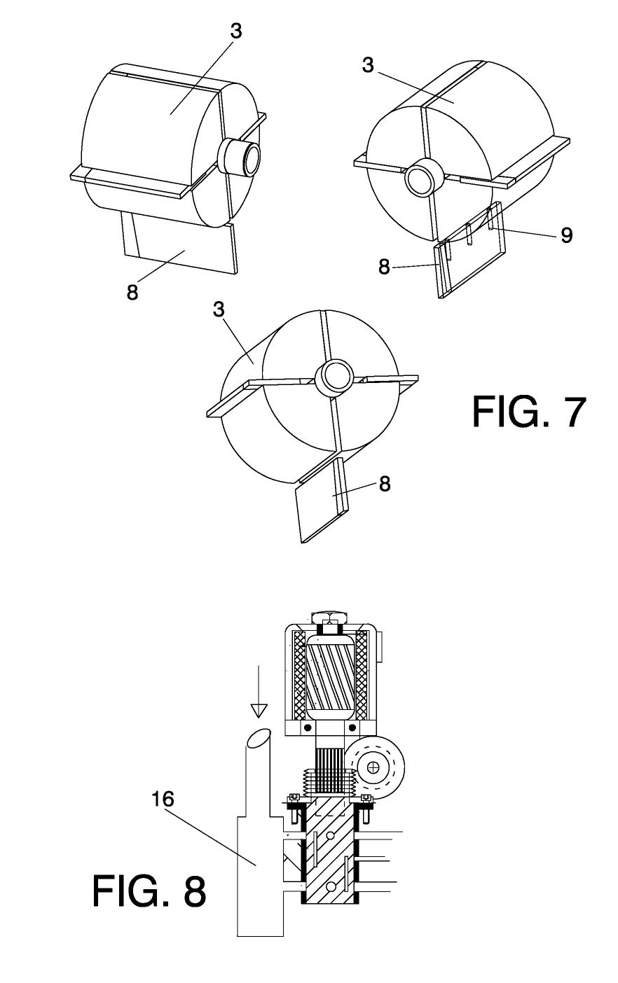

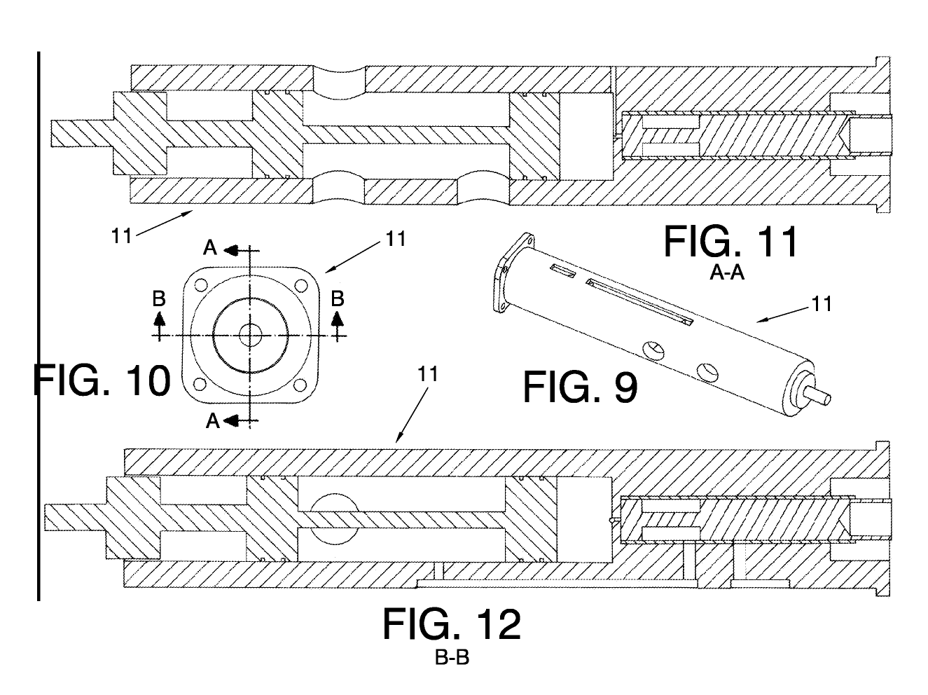

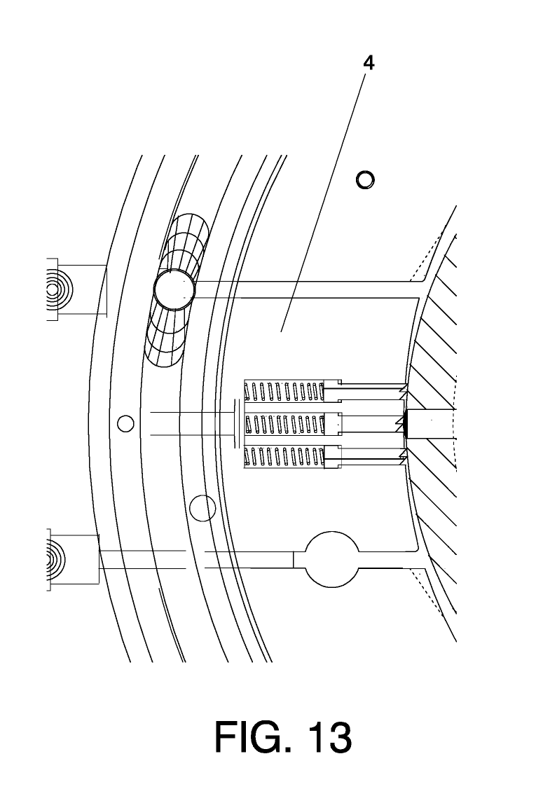

For the radial blades (8) to perform the aforementioned closure with a precision adjustment, they have elastic elements (9)—which can be observed in closer detail in FIG. 7 and which in a preferred embodiment of this invention are springs inserted inside the blades as can be observed in said FIG. 7—said elements are arranged between said blades (8) and the rotor (3) exerting pressure, pressure corresponding to the force inherent to a compressed spring, to provide the latter with automatic position recovery by thus adjusting the blades (8) on the stator (4), more specifically so that the elastic elements (9) which are located inside one of the lateral profiles of the blade (8) exert a force, pushing the blade (8), these are located on the inside of the thickest wall, since the blade can be configured in a wedge shape and can be sectioned while the elastic elements (9) can be springs intended to exert pressure between the blade (8) and the inside of the stator (4).

The stator (4) comprises at least a retainer ring disposed on the inner face thereof intended to carry out the closure of the unit formed by the stator (4) and the rotor (3) in the axial direction and furthermore the stator (4) comprises an air inlet channel (10) intended to supply the compressor and is connected to an inlet channel disposed in a chamber in the rotor (3) and which is offset 45° with respect to the air exhaust channel, already compressed.

The air is driven throughout the engine in various ways, for that for example the compressor also comprises an inlet valve disposed in the air inlet channel (10) and an expulsion valve disposed in the air exhaust channel.

In the aforementioned compressor is at least one, preferably two, cross-sectioned blades which make a labyrinth seal and which can comprise springs inside one of the adapted faces thereof to exert pressure with respect to the peripheral face of the rotor (3) and carry out the blockage of air between the inlet channel and the air exhaust channel. While the stator (4) of the compressor comprises at least two channels wherein are found at least an electronic distribution rod (12) adapted to control shock absorbers (13) arranged on the expulsion valves and the possible imbalances which can arise between pressures as well as an annular pressure and regulation chamber (15) which is connected to the electronic distribution rod (12) which have a non-return valve intended to carry out communication with the compressor as well as an electronically actuated compressor relief valve and a pressure balanced two-way valve adapted to actuate directly on: a boiler or on the boiler and the pressure and regulation chamber.

Once the air and fuel arrive to the combustion block, an ignition is produced in at least one spherical combustion chamber (5), preferably four, which comprise an air inlet channel, an exhaust channel, and a housing for the fuel injector, the ignition whereof, once mixed, is performed by means of at least a spark plug intended to carry out the ignition, which is housed in a hollow part of the combustion block. The combustion block is complemented by an inlet guide valve (14) disposed in the inlet channel to regulate the entrance of air into the combustion chamber (5) and an expulsion guide valve disposed in the exhaust channel to regulate the exit of the exhaust gases.

Once the combustion has been completed, the force generated is transmitted by means of a torque transmission system comprising:
a first shaft which connects a high pressure turbine equipped with a system reduction gear box, and
a second shaft which transmits the power from the system reduction gear box to the shaft of at least a low pressure turbine and to the lower shaft where the following are located: a fan, a current generator, and cooling and lubricating pumps.

In an alternative embodiment of the object of the invention the transmission system is made up of a first shaft which connects the high pressure turbine, intended to generate the operating pressure and equipped with a reduction gear box and auxiliary services—pressure and lubricating pumps, recovery pump, current generator and start-up motor—a second shaft (7″) which transmits the power from the system reduction gear box to a shaft of the (3) rotor of the compressor, and a third shaft which connects the low pressure turbine (6′) of a hot part of the engine (1), to a planetary gear box intended to transmit the torque to: another low pressure turbine located in the front part of the engine (1) and to a fan.

Whatever the embodiment may be, the engine (1) needs lubrication and/or refrigeration and it is for this reason that a lubrication system (16) is incorporated which uses the pressure generated in pressure and recovery pumps disposed in the engine (1) to distribute a lubricating fluid to: bearings in the turbine (6), the valves, the reduction gear box and the planetary gear box. The lubricating and/or cooling system features a series of ducts which are responsible for making the fluid arrive at its destinations.

1-21. (canceled)

22. Reaction engine comprising:
a compressor block equipped with at least a compressor intended to carry out a compression of air that enters the engine and which comprises, in turn, a rotor and a stator,
a combustion block which comprises at least a combustion chamber intended to house an ignition of a fuel together with high pressured air coming from the compressor block,
at least a turbine actuated by exhaust gases produced in the combustion chamber and which comprises a torque transmission system with at least a shaft which is joined to at least the compressor thus carrying out the aforementioned compression of air,
wherein the stator of the compressor is eccentric with respect to the rotor which permits the alternative radial displacement of an array of radial blades disposed on the rotor to carry out the closure in the radial direction of the array formed by the rotor and the stator, and said stator of the compressor comprises shock absorbers arranged on expulsion valves, said shock absorbers being controlled by electronic distribution rods disposed in compressor channels to control said shock absorbers and possible imbalances which may arise between the pressures.

23. The engine of claim 22, wherein the radial blades comprise elastic elements disposed on said blades and the rotor to provide the latter with automatic position recovery, thus adjusting themselves on an inner face of the stator, said elastic elements being located inside one of the lateral profiles of the blade.

24. The engine of claim 22 wherein the elastic elements are springs intended to exert pressure between the blade and the inside of the stator.

25. The engine of claim 22 wherein the blades are at least partially sectioned.

26. The engine of claim 22 wherein the stator comprises at least a retainer ring arranged on the inner face thereof intended to carry out the closure of the array formed by the stator and the rotor in the axial direction.

27. The engine of claim 22 wherein the stator further comprises an air inlet channel intended to supply compressed air to the compressor, said air inlet channel being connected to at least one chamber formed between the stator inner wall and the rotor outer wall, which is offset 45° with respect to an air exhaust channel.

28. The engine of claim 22 wherein the compressor further comprises at least one expulsion valve disposed in the air exhaust channel.

29. The engine of claim 22 wherein the compressor further comprises at least one at least partially sectioned blade adapted to make a labyrinth seal and which comprises elastic elements in the interior thereof on at least one of its faces, which are adapted to exert pressure from the blade with respect to the peripheral face of the rotor to carry out the blockage of the passage of air between the air inlet channel and the air exhaust channel.

30. The engine of claim 22 wherein the stator of the compressor further comprises at least two channels wherein are disposed at least one electronic distribution rod adapted to control shock absorbers arranged on the expulsion valves and the possible imbalances which may arise between the pressures.

31. The engine of claim 30 wherein the stator of the compressor comprises an annular pressure and regulation chamber connected to the distribution rod.

32. The engine of claim 30 wherein the electronic distribution rod comprises a non-return valve intended to carry out connection with the compressor and an electronically actuated compressor relief valve and a pressure balanced two-way valve adapted to actuate directly on: a boiler or on the boiler and the pressure and regulation chamber.

33. The engine of claim 22 wherein the combustion block comprises at least a spherical combustion chamber which comprises:
an air inlet channel,
an exhaust channel, and
a housing for the fuel injector.

34. The engine of either claim 22 wherein the combustion block further comprises at least a hollow space wherein a spark plug is located which is intended to carry out the ignition.

35. The engine of either claim 22 wherein the combustion block comprises an inlet guide valve disposed in the inlet channel to regulate the entrance of air to the combustion chamber and an expulsion guide valve disposed in the exhaust channel to regulate the exit of the exhaust gases.

36. The engine of claim 22 wherein a first shaft connects to a high pressure turbine, intended to generate operating pressure, with a system reduction gear box and auxiliary services, further comprising a second shaft intended to transmit from the system reduction gear box to the shaft of the rotor of the compressor.

37. The engine of either claim 22 further comprising a third shaft which connects at least a low pressure turbine located in a hot part of the engine to a planetary gear box and this, in turn, transmits the torque to frontal low pressure turbines and a fan.

38. The engine of claim 22 further comprising a lubrication system which uses pressure, generated in pressure and recovery pumps arranged in the engine, to distribute a lubricating fluid.

39. The engine of claim 38, wherein the lubricating fluid is distributed by: bearings in turbines, valves, reduction gear box and planetary gear box.

40. The engine of claim 22 wherein the shaft is hollow.

41. The engine of either claim 33 wherein the combustion block further comprises at least a hollow space wherein a spark plug is located which is intended to carry out the ignition.

42. The engine of either claim 33 wherein the combustion block comprises an inlet guide valve disposed in the inlet channel to regulate the entrance of air to the combustion chamber and an expulsion guide valve disposed in the exhaust channel to regulate the exit of the exhaust gases.

43. The engine of either claim 36 further comprising a third shaft which connects at least a low pressure turbine located in a hot part of the engine to a planetary gear box and this, in turn, transmits the torque to frontal low pressure turbines and a fan.
